(19) United States
(12) Patent Application Publication
(10) Pub. No.: US 2016/0217356 A1
(43) Pub. Date: Jul. 28, 2016

(54) System and Method for Encoding and Controlled Authentication

(71) Applicant: Philip Wesby, Stratford-Upon-Avon (GB)

(72) Inventor: Philip Wesby, Stratford-Upon-Avon (GB)

(21) Appl. No.: 15/091,129

(22) Filed: Apr. 5, 2016

Related U.S. Application Data
(63) Continuation of application No. 13/823,368, filed on Mar. 14, 2013, now abandoned.

(30) Foreign Application Priority Data
Sep. 18, 2010 (GB) 1015715.4
Sep. 20, 2010 (GB) 1015628.9
Oct. 7, 2010 (GB) 1016924.1
Oct. 19, 2010 (GB) 1017601.4

(51) Int. Cl. G06K 19/06; G06K 7/14

(52) U.S. Cl. CPC G06K 19/0614; G06K 7/1413; G06K 7/1417

(57) ABSTRACT

A system and method for encoding and controlled authentication of security documents, ID cards, tickets and products and the like is described which can provide a secure means to determine them to be authentic. The method involves encoding the surface of the said security documents or ID cards or tickets and the like with of a pair of identity components comprising a pair of unique numbers, or a combination of a uniquely encoded image and a unique number, or a combination of a unique barcode and a unique number, or a combination of encoded images. The pair of identity components together comprise a challenge response pair and are related such that one component of the pair, the response, is a mathematical derivative of the other component, the challenge. A processing module determines the response by processing the challenge using complex mathematical functions such as one-way mathematical functions. If the processed response matches the encoded response, the challenge response pair is determined to be authentic. The use of one-way mathematical functions renders any attempt to compute the challenge response relation between the identity components outside polynomial time. The invention provides the means to modify the challenge response computation with a password or PIN number such that any document or ticket or product can be locked or unlocked accordingly. When locked, the password or PIN number corrupts the challenge response computation such that the challenge response pair is deemed non-authentic. The invention has direct application to Internet sales transactions.

### PRIORITY

This patent application is a continuation of and claims priority from all priority dates of co-pending U.S. patent application Ser. No. 13/823,368, filed Mar. 14, 2013, and entitled “System and Method for Encoding and Controlled Authentication” (attorney docket number 1503/127). U.S. patent application Ser. No. 13/823,368 is a National Phase filing of and claims priority to PCT/GB2011/001360 filed on Sep. 19, 2011, and entitled “System and Method for Encoding and Controlled Authentication”, which further claims priority from GB Application 1015715.4, filed Sep. 18, 2010, GB Application 1015628.9, filed Sep. 20, 2010, GB Application No. 1016924.1, filed Oct. 7, 2010, and GB Application No. 1017601.4, filed Oct. 19, 2010. The disclosures of each of these applications are incorporated herein by reference in their entirety.

### BACKGROUND OF THE INVENTION

The current invention relates to a system and method for encoding and controlled authentication of security documents, ID cards, tickets and products and the like, which can provide a secure means to determine them to be authentic.

In particular, the invention relates to a system and method for encoding and controlled authentication of security documents, ID cards, tickets and products such as genuine car parts or pharmaceutical products wherein the said documents, or ID cards, or tickets, or product packaging materials or the surface of the products are encoded with a pair of unique identity components wherein one component is a derivative of the other component such that they form a challenge response pair.

More particularly, the invention describes a system and method for encoding and controlled authentication wherein the challenge response pair is printed upon, or cut into the surface of the document or product or product packaging, and wherein the unique response component is computed from the unique challenge component by a processing module using a complex mathematical algorithm such as one using one-way mathematical functions. In this way the unique response component comprises a complex mathematical derivative of the unique challenge component and the use of one-way mathematical functions renders any unauthorised attempt to compute the processing relation between the response and the challenge as outside polynomial time.

If the processed response matches the response encoded on the document, the challenge response pair is determined to be authentic. The invention also provides the means to modify the challenge response computation with a password or PIN number such that any document or ticket or product can be temporarily locked and subsequently unlocked accordingly. When locked, the password or PIN number corrupts the challenge response computation such that the challenge response pair is determined to be invalid such as would be found on a non-authentic document or ticket or product.

More particularly, when applied to event tickets such as Olympics Games tickets or Opera tickets, the invention provides consumers with a means to order and buy tickets securely over the Internet and to register their purchased tickets to a wireless device or server and provide a means to assign a password or PIN number to the said tickets which corrupts the challenge response computation and thereby locks the tickets at the point of sale, rendering the tickets unusable until the tickets are unlocked. In this way, the tickets may not be intercepted and used by third parties such that replacement tickets may be freely issued or refunds given if the said tickets are mislaid.

This patent application relates in part to an invention of an earlier patent application WO 2008/093093 by the same applicant entitled System and Method for Encoding and Authentication having priority date Feb. 2, 2007. In this patent application is taught the method of encoding documents with one or more unique encodings to provide a process for determining that a document or product is authentic.

The current invention substantially extends the teaching of this earlier patent application by providing the additional means to interact with the authentication process and thereby control the determination of the processed response such that the response can be actively modified by an authorised person, thereby providing the means to lock and unlock security documents and tickets and thereby control their validity when their authenticity is challenged.

Today, passports and other identification documents and events tickets all form an integral means to authenticate people and validate their right of passage across borders, or entry into controlled areas and or to pass ticket barriers to attend events. Identity theft is increasing and means to further reduce the misuse of forged documents are sought by authorities.

Consumers often buy products from Internet websites or from sales outlets where limited means exist to determine whether the website is an authorised seller, whether the seller actually possesses the advertised products, or is indeed selling genuine authentic products. A means is definitely needed, which increases the security of the sales transaction as well as one, which enables the consumer to determine that the advertised products exist and that the sales outlet or the website is authentic.

Security documents such as passports or ID cards can be mislaid. Often it may take some time before a person, who has mislaid a security ID card or passport, decides to start the laborious process of reporting the loss. Clearly a technology, which provides the means to render a security document temporarily unusable gives a person peace of mind that while the document is missing, any fraudulent use will be identified should its authenticity be challenged during a standard authenticity check.

Branded products are liable to being counterfeited and there are limited means for a consumer to determine whether a product is genuine or counterfeit. In some cases, the use of counterfeit safety products can lead to persons suffering injury and any means to improve the means to identify non-authentic products and exclude their use is needed.

Pharmaceutical medicines are frequently packaged in blister packs. While pharmaceutical companies take extraordinary care to provide means to authenticate the outer packaging of pharmaceutical medicines, no such anti-counterfeiting technology is provided to the blister packs containing the medicines. Pharmaceutical products, which are manufactured in one territory for sale in another territory, are often repackaged in the other territory to include healthcare information in the language of the other territory. It is at this point when the security of the authentic outer packaging is breached that counterfeit medicine manufacturers have the opportunity to misuse the discarded packaging. Any system and method, which can provide an improved means to authenticate pharmaceutical products at the blister pack level, will serve to reduce the amount of counterfeit medicines in circulation.

In addition to being able to determine that a product is authentic, it is often important and valuable to know if the product has passed its use-by date. A pharmaceutical product contained in a blister pack may not have this information printed upon it. A system and method, which can provide the means to supply this information, will help reduce any problems caused by a patient taking a medicine, which may have deteriorated over time. In addition, any further means, which can modify the authentication procedure after a batch of product has passed its use-by date, will further improve patient safety.

Generally, anti-counterfeiting technologies for security documents such as bank notes and passports continue to evolve in complexity to make their features ever more difficult to reproduce by the counterfeiter. The latest Intaglio, Optically Variable Device and Optically Variable ink technologies are so advanced that even the most sophisticated counterfeiter cannot create a document, which will pass the scrutiny of the new generation of document validation technologies. There is an alternative view however, that in their complexity, these advanced features no longer serve to reduce the number of counterfeit documents in circulation.

The general public is so unaware of the complex features that home scanner-copier equipment and a supply of metal foil holograms continue to provide a source of counterfeit documents. The security document industry, in its drive towards covert technologies such as infrared fluorescence, has shifted the focus of engagement with the counterfeiter towards removing counterfeit documents from circulation when they eventually pass through sophisticated authentication equipment.

The industry maintains the view that if a document can be seen, it can be counterfeited. A technology, which challenges this view and makes it difficult to pass the scrutiny of a simple authentication check and thereby improve the safety and security of products and services, is highly desirable.

Further to the limitations of existing methods used for enhancing the authentication of passports, security documents, ID cards, tickets and branded products and pharmaceutical products and the like, and so far as is known, no optimum system and method for encoding and controlled authentication is presently available which is directed towards the specific needs of this problem area as outlined.

### OBJECTS OF THE INVENTION

Accordingly, it is an object of the present invention to provide an improved system and method for encoding and controlled authentication for security documents, passports, ID cards, tickets and products and the like in which a pair of unique identity components is printed upon the surface of, or cut into the surface of said security documents, passports, ID cards, tickets and products and the like, wherein the said pair comprises: a pair of unique numbers, or a pair of unique alphanumeric strings in any language, or a combination of a uniquely encoded image and a unique number or alphanumeric string, or a combination of a unique barcode and a unique number or alphanumeric string, or a combination of encoded images such as 2-dimensional images, or images which comprise different patterns When illuminated by infrared light or ultraviolet light or of light of specific spectral frequencies.

It is a further object of one embodiment of the present invention to provide a system and method for encoding and controlled authentication for security documents, passports, ID cards, tickets and products and the like in which a pair of unique identity components is printed upon the surface of or cut into the surface of said security documents, passports, ID cards, tickets and products and the like, wherein each unique identity component of the said pair is related to the other unique identity component of the said pair in that one unique identity component is the derivative of the other said unique identity component and wherein the pair of unique identity components together form a challenge response pair.

It is a further object of one embodiment of the present invention to provide a system and method for encoding and controlled authentication for security documents, passports, ID cards, tickets and products and the like in which a pair of unique identity components is printed upon the surface of or cut into the surface of said security documents, passports, ID cards, tickets and products and the like, wherein a processing means is used to process mathematically the first unique identity component (the challenge) and thereby derive the second unique identity component (the response and wherein one-way mathematical functions are used to derive the second unique identity component (the response).

It is a further object of one embodiment of the present invention to provide a system and method for encoding and controlled authentication for security documents, passports, ID cards, tickets and products and the like, in which a pair of unique identity components is printed upon the surface of, or cut into the surface of each of said security documents, passports, ID cards, tickets and products and the like, wherein the authenticity of any one of the said security documents, passports, ID cards, tickets and products and the like can be verified by processing the first unique identity component of the pair (the challenge) wherein the challenge is transmitted to a challenge response processing means such as a challenge response server, or the challenge is entered into a device comprising the challenge response computational algorithm, or depending upon the nature of the unique identity component, the component may be read using a bar code reader, or read by a 2-dimensional encoded-image reader, or illuminated under different spectral frequencies and read by an optical reading device, wherein in each case a mathematical representation of the challenge is produced, and then passed to a processing means, and wherein the said processing means computes the second unique identity component of the pair (response), and wherein the said security document, passport, ID card, ticket or product is determined to be authentic if the received response matches the second unique identity component on the said security document, passport, ID card, ticket or product.

It is a further object of one embodiment of the present invention to provide a system and method for encoding and controlled authentication for security documents, passports, ID cards, tickets and products and the like in which each comprises a pair of a first unique identity component and a second unique identity component which together comprise a challenge response pair and wherein a challenge response processing means is provided which can determine the authenticity of any said security document, passport, ID card, ticket or product by processing the unique challenge and deriving the response, wherein if a derived response matches the second unique identity component on the one security document, or passport, or ID card, or ticket, or product which is challenged, then that one security document, or passport, or ID card, or ticket, or product is determined to be authentic.

It is a further object of one embodiment of the present invention to provide a system and method for encoding and controlled authentication for security documents, passports, ID cards, tickets and products and the like in which each comprises a pair of a first unique identity component and a second unique identity component which together comprise a challenge response pair and wherein a challenge response processing means is provided which can determine the authenticity of any said security document, passport, ID card, ticket or product by determining that the computed response matches the response on the said documents or products wherein both the first and second identity components are input into a reading device and the reading device is either a stand alone device and comprises the challenge response processing module or the reading device comprises a transaction gateway device which is connected to a remote challenge response processing means such as a challenge response server such that the authentication procedure involves determining that the challenge and response together form a valid pair and wherein the result of the authentication check is a pass or a fail wherein the challenge response pair are determined to be valid or invalid.

It is a further object of one embodiment of the present invention to provide a system and method for encoding and controlled authentication for security documents, passports, ID cards, tickets and products and the like in which each security document, passport, ID card, ticket or product or the like comprises a pair of unique identity components comprising a challenge response pair in which the response is a mathematical derivative of the challenge and wherein the response is computed using mathematical functions such as one-way mathematical functions which are chosen from the class of functions having the property that they cannot be reverse-engineered such that the processing time required to derive the challenge from the response is outside polynomial time, and wherein the challenge response processing means further comprises a memory means such as a database or data storage means to associate a challenge with an intervention code and to store a challenge together with an intervention code.

It is a further object of one embodiment of the present invention to provide a system and method for encoding and controlled authentication for security documents, passports, ID cards, tickets and products and the like in which each comprises a pair of unique identity components comprising a challenge response pair and wherein a challenge response processing means is provided to determine the authenticity of any said security document, passport, ID card, ticket or product by processing the challenge and deriving the response, and wherein authenticity is determined by inspection, and wherein the challenge response processing means comprises the functionality to associate a challenge with an intervention code and to store a challenge together with an intervention code, wherein the challenge response processing means further comprises the means to receive an instruction to activate the intervention code associated with a unique challenge such that the challenge response processing means determines an incorrect response for a challenge which is associated with an active intervention code, such that the received response no longer matches the second unique identity component on the said security document, passport, ID card, ticket or product or the like, and wherein the said security document, passport, ID card, ticket or product or the like is declared to be non-authentic.

It is a further object of one embodiment of the present invention to provide a system and method for encoding and controlled authentication for security documents, passports, ID cards, tickets and products and the like in which each comprises a pair of unique identity components comprising a challenge response pair and wherein a challenge response processing means is provided to determine the authenticity of any said security document, passport, ID card, ticket or product by processing the challenge and deriving the response, and wherein authenticity is determined by inspection, and wherein the challenge response processing means comprises the functionality to associate a challenge with an intervention code and to store a challenge together with an intervention code, wherein the challenge response processing means further comprises the means to receive an instruction to activate the intervention code and thereby cause the challenge response processing means to compute an incorrect response while the intervention code is active, wherein the challenge response processing means further comprises the means to receive a second instruction to deactivate the intervention code associated with a unique challenge such that upon receiving the said second instruction, the challenge response processing means subsequently computes the correct response to the challenge which is identical to the response on the said security document, passport, ID card, ticket or product or the like, and wherein the said security document, passport, ID card, ticket or product or the like is declared to be authentic.

It is a further object of one embodiment of the present invention to provide a system and method for encoding and controlled authentication for security documents, passports, ID cards, tickets and products and the like in which each comprises a pair of unique identity components comprising a challenge response pair and wherein a challenge response processing means is provided which can determine the authenticity of any said security document, passport, ID card, ticket or product by processing the challenge and deriving the response, and wherein any such security document, passport, ID card, ticket or product may be locked by associating an intervention code with a particular first unique identity component (challenge) and activating the said intervention code thereby causing an incorrect response to be computed by the challenge response processing means while the intervention code is active, and wherein any such security document, passport, ID card, ticket or product may be unlocked by sending an instruction to deactivate the intervention code associated with a particular first unique identity component thereby causing the correct response to be computed by the challenge response processing means. Consequently, the authenticity of each of the said security documents, passports, ID cards, tickets and products and the like can be disabled by sending an instruction to the challenge response processing means to cause it to activate the intervention code associated with a particular challenge, and wherein the authenticity of each the said security documents, passports, ID cards, tickets and products and the like can be re-enabled by sending an instruction to the challenge response processing means to cause it to deactivate an intervention code.

It is a further object of one embodiment of the present invention to provide a system and method for encoding and controlled authentication for security documents, passports, ID cards, tickets and products and the like in which each comprises a pair of a first unique identity component and a second unique identity component wherein said components together comprise a challenge response pair, and wherein a challenge response processing means is provided which derives the unique response from the unique challenge and wherein the challenge response processing means further comprises the means to register a device having a unique identity such as a wireless device and or a device having an IP address and or a fixed line device and or a device having a MAC address and thereby authorise that particular device to be further associated with one or more first unique identity components wherein each first component comprises a unique challenge and is associated with a unique authentication process and whereby after becoming registered, the said device is authorised to send instructions to the challenge response processing means such that it can activate and deactivate intervention codes associates with a particular challenge and thereby control the authentication process associated with that challenge.

It is a further object of one embodiment of the present invention to provide a system and method for encoding and controlled authentication for security documents, passports, ID cards, tickets and products and the like in which each comprises a pair of a first unique identity component and a second unique identity component wherein said components together comprise a challenge response pair, and wherein a challenge response processing means is provided which further comprises the means to register wireless and or fixed line devices to each be permitted to be associated with one or more first unique identity components wherein each component is associated with one security document, or passport, or ID card, or ticket or product or the like and wherein each registered device is authorised to store a password and or PIN code for each associated first unique identity component such that the said authorised device may activate an intervention code by using the stored password or PIN code and thereby modify the challenge response processing of any first identity component associated with an active intervention code, such that the challenge response processing means computes an incorrect response wherein the said one security document, or passport, or ID card, or ticket or product or the like whose first unique identity component is associated with an activated intervention code is determined to be non-authentic when the incorrectly computed response received from the challenge response processing means is determined by inspection to be different from the second unique identity component on the said one security document, or passport, or ID card, or ticket or product or the like.

It is a further object of one embodiment of the present invention to provide a system and method for encoding and controlled authentication for security documents, passports, ID cards, tickets and products and the like in which each comprises a pair of a first unique identity component and a second unique identity component wherein said components together comprise a challenge response pair, and wherein a challenge response processing means is provided to compute a unique response for any received unique challenge and wherein the challenge response processing means further comprises the means to register one or more wireless and or fixed line devices to each be permitted to be associated with one or more first unique identity components wherein each component is associated with one security document, or passport, or ID card, or ticket or product or the like and wherein each registered device is authorised to be associated with one or more first unique identity components and furthermore, the said challenge response processing means further comprises the means to associate different data types with one or more first unique identity components such that in accordance with different applications, in the instance that an authentication challenge of a first identity component is made, it will cause the computed response to be transmitted with any data stored in association with that first component.

It is a further object of one embodiment of the present invention to provide a system and method for encoding and controlled authentication for security documents, passports, ID cards, tickets and products and the like in which each comprises a pair of a first unique identity component and a second unique identity component wherein said components together comprise a challenge response pair, and wherein a challenge response processing means is provided to compute a unique response for any received unique challenge and wherein the challenge response processing means further comprises the means to register one or more wireless and or fixed line devices to each be permitted to be associated with one or more first unique identity components wherein each component is associated with one security document, or passport, or ID card, or ticket or product or the like and wherein each registered device is authorised to be associated with one or more first unique identity components and wherein a PIN or password may be subsequently registered to activate an intervention code which can cause the challenge response to be miscalculated and wherein the credit card used for purchase having a readable magnetic strip or a driving licence having a machine readable component or other identification document having a machine readable component may be used as the means to generate the PIN or password to lock the challenge response calculation such that during the process of authenticating the said security document, or passport, or ID card, or ticket or product, the said credit card or said driving licence or said other identification document must be read in combination with the document or product being authenticated to determine a valid authentication.

It is a further object, of one embodiment of the present invention to provide a system and method for encoding and controlled authentication for security documents, passports, ID cards, tickets and products and the like in which each comprises a pair of a first unique identity component and a second unique identity component wherein said components together comprise a challenge response pair, and wherein a challenge response processing means is provided to compute a unique response for any received unique challenge and wherein the challenge response processing means further comprises the means to register one or more wireless and or fixed line devices to each be permitted to be associated with one or more first unique identity components wherein each component is associated with one security document, or passport, or ID card, or ticket or product or the like in which a wireless or fixed device comprising a unique identity may be registered to interact with the authentication process and thereby provide the means to lock and unlock the authentication codes such that the invention may be used by a consumer to determine that advertised products are indeed authentic, and to enable a consumer to buy events tickets and the like over the Internet such that the invention makes it possible for the consumer to determine that the advertised tickets are indeed authentic by verifying that the published response on the ticket corresponds to the computed response determined by sending the challenge to a registered and authorised challenge response processing means or server, and wherein the tickets can be registered to a consumer and or a device by defining a unique password or PIN during the sales transaction process and thus making that consumer and or device authorised to lock those tickets until they are received by the consumer, thereby improving the security of the transaction and rendering the tickets to be determined non-authentic and unusable until unlocked by the legitimate owner of the tickets such as before passing through a ticket barrier or wherein a consumer enters the unlock PIN code or password at the ticket barrier itself via data entry means or provides a credit card or ID card having a machine readable code, which was used to lock the challenge response to be read at the ticket barrier.

It is a further object of one embodiment of the present invention to provide a system and method for encoding and controlled authentication of products such as food products, and or perishable products and or pharmaceutical products, which would benefit from increased anti-counterfeiting methods whereby each of said products comprises a unique challenge response pair and wherein a challenge response processing means is provided to authenticate the products by computing a response, wherein the challenge response processing means is associated with a data storage means which stores different data types and wherein a challenge response process can determine that a product is authentic and also provide information about the validity of the product such as the sell-by date of a food product, or the sell-by date of a perishable product or a use-by date of a pharmaceutical product, and wherein the said data storage means may be updated by an operator such that when a batch of product is determined to have passed its sell-by or use-by date, then an intervention code may be activated to cause any challenge response to be miscalculated and sent with an appropriate message advising the consumer that the product should no longer be used.

It is a further object of one embodiment of the present invention to provide a system and method for encoding and controlled authentication of products such as pharmaceutical products in particular wherein each of said products comprises a unique challenge response pair printed or etched into the surface of the pharmaceutical packaging or blister pack and wherein a challenge response processing means is provided to authenticate the products by computing a response, whereby should use of the product be discontinued, an operator may cause the activation of an intervention code which causes the miscalculation of the correct response and includes a data message to be sent to patients about the use of the pharmaceutical product immediately.

It is a further object of one embodiment of the present invention to provide a system and method for encoding and controlled authentication of products such as pharmaceutical products in particular wherein each of said products comprises a unique challenge response pair printed or etched into the surface of the pharmaceutical packaging or blister pack, and wherein patients taking the prescribed pharmaceutical product are informed to register the product to a device by registering a device and sending some personal information such as age, gender, and location and the like and then sending the first unique identity component to the destination IP address of a challenge response processing means, or by reading a bar code from each part of the pharmaceutical packaging and registering this to a device at the point of sale, wherein in each case the response from the challenge response processing means will be identical to the second identity component on the packaging, and wherein the recipient may receive a data file containing such data as date of manufacture, place of manufacture, point of sale, date of sale, use-by date, product description, contraindications and warnings of side effects, use instructions and the like.

It is a further object of one embodiment of the present invention to provide a system and method for encoding and controlled authentication of products such as pharmaceutical products, which further provides a means to determine real market data of the number and location of patients using a particular pharmaceutical product.

It is a further object of one embodiment of the present invention to provide a system and method for encoding and controlled authentication of documents such as security documents and passports and ID cards and tickets and the like wherein the said security documents and tickets and the like may be rendered temporarily non-authentic when not in use or if mislaid such that the said documents may be intercepted if used fraudulently when made subject to an authenticity check and wherein the said documents may be rendered authentic again when they are to be used or when they are rediscovered.

It is a further object of one embodiment of the present invention to provide a system and method for encoding and controlled authentication of branded products such that genuine branded products comprise a genuine challenge response pair which can be authenticated by sending the challenge to a challenge response processing means using a registered device and wherein according to different embodiments, additional data relating to the genuine product may be sent back to the registered device challenging the authenticity of the product, wherein the additional data includes data types such as date of manufacture, place of manufacture, point of sale, date of sale, use-by date, product description, use instructions and the like and wherein in the case of a product warning report, all registered devices for that product may be sent a warning message.

It is a further object of one embodiment of the present invention to provide a system and method for encoding and controlled authentication of products, which can form the basis of a secure method for making purchases over the Internet wherein a consumer is provided with both the unique identity components associated with the product and can independently verify that the second unique identity component matches the response sent by an authorised challenge response server and that the authorised server enables the registration of a device and the registration of a PIN or password to activate an intervention code and thus cause the authorised challenge response server to compute an incorrect response when the first unique identity component is challenged, and wherein the consumer may further receive data such as data relating to the product, data relating to the registration of the ownership of the product, and data relating to the purchase transaction history of the product thereby validating the presence and ownership of a product and thereby reducing the possibility of multiple sales of a single product or fraudulent advertising of a product which does not exist.

Other objects and advantages of this invention will become apparent from the description to follow when read in conjunction with the accompanying drawings.

### BRIEF SUMMARY OF THE INVENTION

Certain of the foregoing and related objects are readily attained according to the present invention by the provision of a novel system and method for encoding and controlled authentication of security documents, ID cards, tickets and products and the like, which can provide a secure means to determine them to be authentic. This invention is directly and widely applicable to travel documents such as passports, and personal identification documents such as driving licences, pilot licences, contracts, promissory notes, bank notes, marriage certificates, birth certificates, and events tickets and lottery tickets as well as to products of all kinds.

According to the invention, the said documents, or ID cards, or tickets, or product packaging materials or the surface of the products are encoded with a pair of unique identity components wherein one component is a derivative of the other component such that they form a challenge response pair. The challenge response pair is printed upon, or cut into the surface of the document or product or product packaging, and provides a means to check authenticity using a challenge response processing module or server wherein the unique response component is computed from the unique challenge component by a processing module using a complex mathematical algorithm such as one using one-way mathematical functions and wherein inspection determines authenticity by confirming that the response sent by the challenge response processing module matches the response encoded on or printed upon the said documents, or ID cards, or tickets, or product packaging materials or products.

Valid authentication is determined either by sending the challenge to a challenge response processing means and comparing the computed result with the response on the document or product, or both the challenge and response are sent to a challenge response processing means and the challenge response pair are determined to be a valid pair and the response is a genuine derivative of the challenge. In the instance that the challenge and response are represented by encoded images, in one embodiment a single encoded image may comprise both challenge and response such that a camera device can capture the single image and determine that the image comprises a valid challenge response pair.

In particular the current invention is particularly suited for authentication and validation of products such as pharmaceutical products to provide a means to determine their authenticity at a blister pack level while providing a means to provide a communications channel to provide data to patients taking a particular medication to inform them that a particular pharmaceutical product has passed its sell-by date or if they need to be informed of new adverse report warnings.

The invention also provides a highly secure means to verify the authenticity of products being sold over the Internet wherein a consumer can both authenticate a product as well as determine the existence of the product and the current registered owner of a product before purchase is made. In addition, the invention is highly suited to the sale of event tickets made over the Internet because it provides the mechanism to authenticate that the seller is genuine as well as the means to validate the existence of the tickets, to validate the location of the tickets, to validate that the tickets are authentic, to validate that the tickets are for sale, to validate that the tickets are currently unsold to anyone, to reserve the tickets during the purchase transaction and to register them to a device and assign a password or PIN such that the tickets may be locked during the purchase transaction in order to render them to be temporarily invalid. In this way the sales transaction is made more secure and should the tickets be lost in the post, the purchaser may be refunded in the knowledge that the challenge response authentication server maintains a record of the transaction and authentication status and the tickets can be proven to be invalid and unusable by any third parties.

Other objects and features of the present invention will become apparent from the following detailed description considered in connection with the accompanying drawings, which disclose several key embodiments of the invention. It is to be understood, however, that the drawings are designed for the purpose of illustration only and that the particular applications are given by way of example only and do not limit the scope of the invention.

### BRIEF DESCRIPTION OF THE DRAWINGS

The foregoing features of embodiments will be more readily understood by reference to the following detailed description, taken with reference to the accompanying drawings, in which:

FIG. 1 illustrates a schematic showing two examples of a security document comprising different examples of the challenge response encoding according to different embodiments of the invention.

FIG. 2 illustrates a schematic showing an example of the distribution of network elements and devices used during a challenge response authentication transaction according to one embodiment of the invention.

FIG. 3 illustrates a flow diagram showing an example of a challenge response authenticity check transaction according to one embodiment of the invention.

FIG. 4 illustrates two flow diagrams showing an example of the registration of a device with a challenge response authentication server and the registration of a PIN and password to be used for the activation and deactivation of an intervention code according to one embodiment of the invention.

FIG. 5 illustrates a flow diagram showing an example of an Internet sales transaction using the authenticity check transaction according to one embodiment of the invention.

FIG. 6 illustrates an example of how the PIN can be based upon a random element of the document structure or surface.

### DESCRIPTION OF A PREFERRED EMBODIMENT

Reference will now be made in detail to some specific embodiments of the invention including the best modes contemplated by the inventor for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as defined by the appended claims. The following description makes full reference to the detailed features as outlined in the objects of the invention.

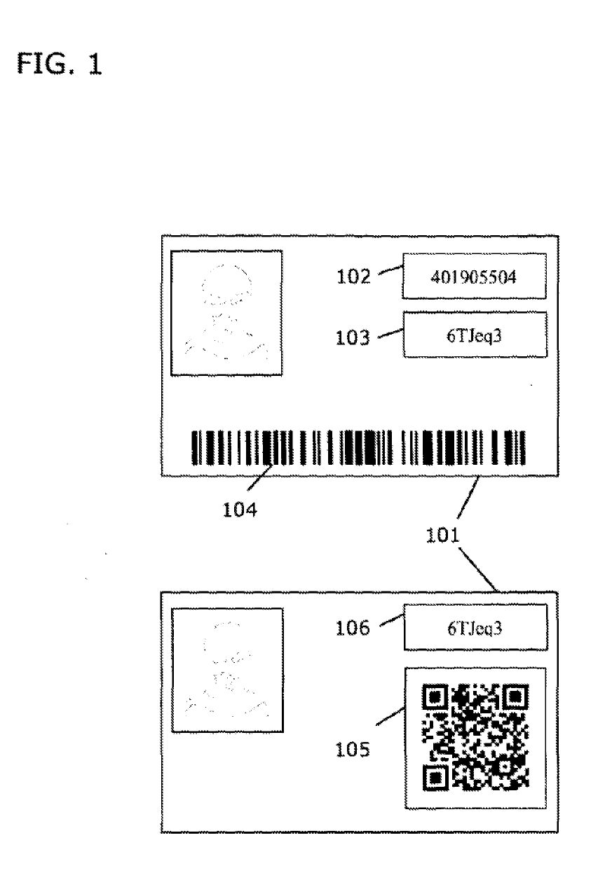

Referring now in detail to the drawings and in particular FIG. 1 thereof, therein illustrated is a schematic showing an example of a security document comprising different examples of the challenge response encoding according to different embodiments of the invention.

In this example, which is suitable for a security document such as a passport, or an ID card, or a visa vignette, or a judicial paper, or a tax banderol, or bank note, or a ticket, or product packaging, or can be applied to the surface of a product, is shown two examples of an ID card (101). In the first example, the ID card (101) comprises two unique identity components (102, 103), wherein a first identity component (102) is a unique serial number, and the second identity component (103) is an alphanumeric string. The two identity components (102, 103) are intrinsically linked such that together they comprise a unique pair wherein the second component (103) is derived mathematically from the first component (102).

Below the two unique identity components is shown a barcode (104), which may comprise an alternative representation of the first unique identity component (102) and which may provide an efficient data capture means for the challenge using a barcode reader. In the example below is shown the challenge in the form of a 2-dimensional barcode (105) and the response in the form of an alphanumeric code (106). Suitable 2D barcode reading software may be used to read the 2-dimensional barcode (105) wherein a mathematical representation of the image is processed by a challenge response processing means, such as using a handheld device or sent to a server, and wherein the response calculated by the challenge response server determines authenticity if the received response matches the response (106) on the ID card. According to different embodiments, and different applications, the first unique identity component or challenge may be encoded into a magnetic strip to facilitate the card being read by a card reader. Alternatively, an encoded image or coating on the card may comprise materials which fluoresce under different frequencies of radiation, or which emit light in the visible range when illuminated by infrared or ultraviolet light, wherein the data in the image only reveals itself under the appropriate illumination. Such covert features further improve the security of the card. For any such encoding, a suitable encoded-image reader is employed to read the first unique identity component. In other examples, such as for a pharmaceutical blister pack, the challenge response encodings may be printed on the metal foil or etched into the metal foil.

Valid authentication is determined either by sending the challenge to a challenge response processing means and comparing the computed result with the response on the document or product, or both the challenge and response are sent to a challenge response processing means and the challenge response pair are determined to be a valid pair and the response is a genuine derivative of the challenge. In the instance that the challenge and response are represented by encoded images, in one embodiment a single encoded image may comprise both challenge and response such that an image capture and processing device can capture the single image and transmit the single image or the mathematical derivative of the single image to a challenge response processing means to determine that the image comprises a valid challenge response pair.

Preferably, the second component or response (103) is computed from the first component or challenge (102) using a challenge response processing means, which makes use of complex mathematical methods such as those employing one-way mathematical functions, which are highly secure because they possess the property that the mathematical challenge response computation cannot be reverse-engineered such that the challenge (102) cannot be derived from the response (103).

One-way functions are functions that are easy to compute but difficult to invert, where the level of difficulty refers to the average complexity of the inverting task. These functions can only be attacked by employing brute force methods in which all possibilities are tried one by one. The existence of one-way functions is the cornerstone of modern cryptography. Almost all cryptographic primitives imply the existence of one-way functions, and many of them can be constructed based either on the existence of one-way functions or on related versions of this assumption.

In computational complexity theory, the time required to solve a computational problem using a computing device must be achievable in a meaningful time period called polynomial time. Formally, to say that a problem can be solved in polynomial time is to say that there exists an algorithm that, given an n-bit instance of the problem as input, the algorithm can produce a solution in time O(n^{c}), where c is a constant that depends on the problem but not the particular instance of the problem, and where O is the big O notation or Bachmann-Landau notation of the function and describes the limiting behaviour of a function when the argument tends towards a particular value or infinity.

Now known as Cobham's Thesis, Alan Cobham's 1965 paper entitled “The intrinsic Computational Difficulty of Functions” asserts that computational problems can be feasibly computed on some computational device only if they can be computed in polynomial time and the paper outlines a method to determine if problems are solvable in this meaningful time period. For example, a function that runs in exponential time might have a running time requiring 2ⁿ computations using a 1 GHz (10⁹ Hz) processor, which would take approximately (2¹⁰⁰≈10⁹)÷1.3×10²¹ seconds, which is (1.3×10²¹÷31556926 years)÷4.1×10¹³ years. Such a function is termed outside polynomial time.

In a preferred embodiment, the challenge response processing means (105) makes use of one-way mathematical functions and thus renders the determination of the challenge from the response as a computational problem, which is outside polynomial time. The use of one-way functions renders impossible the calculation of the inverse function to such a challenge response because no such inverse function exists.

In one embodiment of the challenge response processing means, a serial number or mathematical derivative of a barcode or encoded image is sent to the challenge response processing means. Each mathematical character in the number is read separately and passed to a separate mathematical algorithm. Each algorithm may comprise a one-way function wherein each mathematical character thus provides one input to each of the separate mathematical algorithms. For example, a 12-character number e.g. 785634235611 provides 12 separate inputs of 7, 8, 5, 6, 3, 4, 2, 3, 5, 6, 1, and 1 to twelve separate one-way functions. The results calculated by the 12 one-way functions are computed together using other one-way functions to provide a unique result. This result can be transformed into an alphanumeric string using base 64 and assigning upper and lower case alphabet characters a-z, and A-Z, and the numbers 0-9 and 2 other characters such as < and >. The transformation into base 64 can be done via a mapped array where the base 64 characters are not generated sequentially but are selected from a predetermined but non-linear mapping such that the array is populated randomly.

The randomly populated array will be the permanent mapping for the challenge response computation when transforming the one-way function computation into base-64. This capability to assign a unique mapping of the base-64 character representation provides a further increase in ruggedness against 3^{rd} parties attempting to reverse engineer the computation such that the number of potential combinations possible which must be processed using brute force methods is thereby increased by a factor of 1.3×10⁸⁹. This number is very large: there are considered to be 1×10⁸⁰ atoms in the Universe.

In this way, different challenge response servers can be created and operated by different parties in full knowledge that there will be no correspondence between the responses computed by each of them for the same challenge number which was provided for computation.

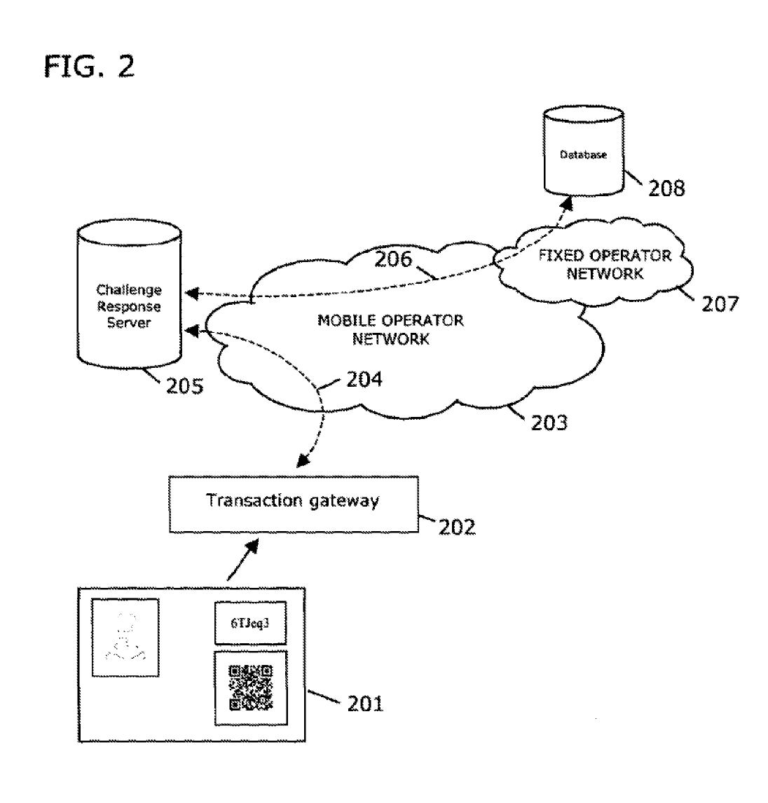

Now with reference to FIG. 2 is shown an example of the distribution of network elements and devices used during a challenge response authentication transaction according to one embodiment of the invention. A product (201) whose authenticity is being challenged has its first unique identity component or challenge data entered into a transaction gateway device (202). As explained previously, the challenge data may comprise several different forms such as a bar code, or a serial number, or an alphanumeric string, or a magnetic strip, or an encoded image.

The transaction gateway device (202) comprises the necessary functionality to read the encoded challenge such that it can be sent to a challenge-response processing module or server. The transaction gateway device may be a fixed line device or a wireless device such as a mobile phone or smart phone or multi media terminal and the challenge data may be entered into the mobile device and sent as a text message or multimedia message, or read using appropriate data reading equipment such as a camera or barcode reader. If the challenge is an encoded image, a camera associated with the device can be used to capture and send the image to a challenge-response processing module. Alternatively, the transaction gateway may possess the capability to decode the challenge and send a mathematical representation to the challenge-response processing module or server.

In some embodiments, according to different applications, the device itself may possess the challenge-response processing module.

In the example of FIG. 2, the product (201) is depicted as an ID card. The challenge is depicted as a 2-dimensional barcode, which may be decoded by an appropriate means associated with the transaction gateway device (202). The transaction gateway device may comprise a multimedia device with the means to decode the 2-dimensional barcode. In this example, a mathematical representation of the challenge is sent across the wireless network (203) via different network elements (204) to a remote challenge-response transaction-processing server (205). The challenge response server (205) comprises the capability to process the unique challenge and to compute mathematically the unique response using one-way mathematical functions. After the challenge is processed, the computed response is sent back to the transaction gateway device, which challenged the authenticity of the product (201). Inspection determines that the response matches the second unique identity component encoded on the product or document surface.

The challenge response server comprises the data storage means to associate different data types with particular first identity components or challenge encodings.

In addition the challenge response server comprises the means to register one or more transaction gateway devices such as a consumer multimedia device and associate that registered device with a unique first identity component challenge.

In this way, the challenge response server provides the means to determine the identity of a device, which is making the challenge. In addition, a record of the challenges can be stored in addition to the times and dates of the challenges as well as the locations of the challenging devices. Periodically, data files can be sent (206) across the mobile operator network (203) and or the fixed operator network (207) to a database (208), which is associated with a particular set of challenge response transaction data records.

In this way events can be monitored to provide differential data responses according to different authentication applications of the invention. The databases may be associated with national data archives, or company information, or validity checks of ID cards of employees who have recently left an organisation, or product registration records, or pharmaceutical product use-by date data and the like.

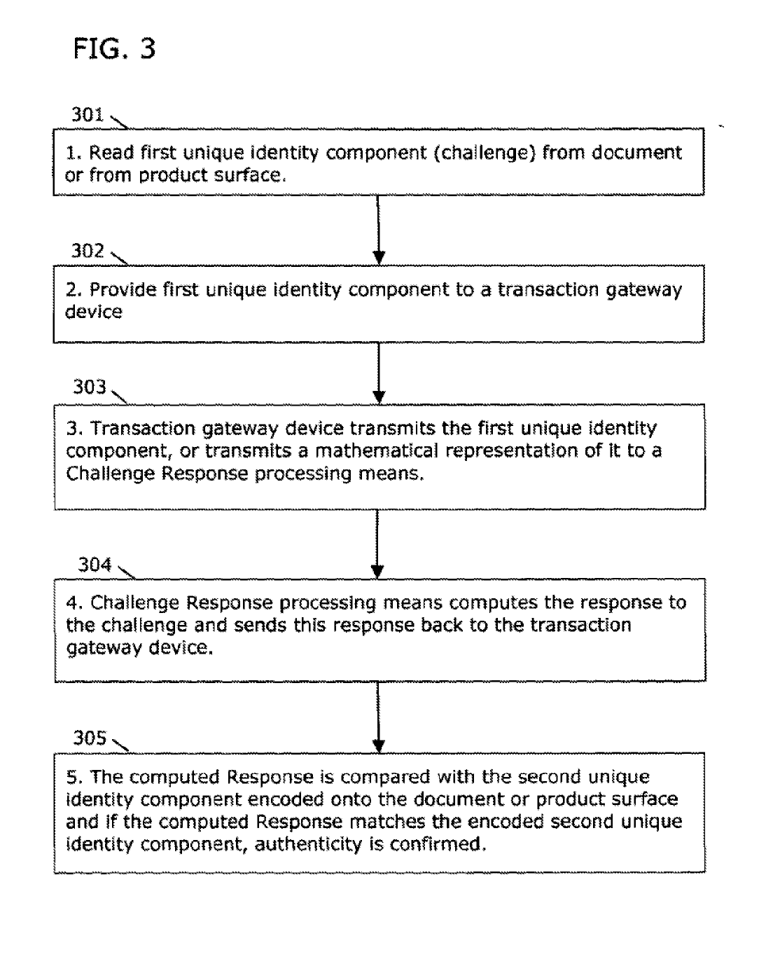

Now with reference to FIG. 3 is shown a flow diagram detailing an example of a challenge response authenticity check transaction according to one embodiment of the invention.

First the first unique identity component or challenge is read from the document or from the product surface (301). After this, the challenge is provided to a transaction gateway device either by entering a number or text string manually, or by reading a bar code using a barcode reader, or by reading a 2-dimensional barcode or by illuminating an encoded image with radiation of a particular frequency range (302).

Next the transaction gateway device transmits the first unique identity component, or transmits a mathematical representation of the first unique identity component to a challenge response processing means such as an onboard processing module or a remote challenge response transaction server (303).

The challenge response processing means then computes the response from the challenge using complex mathematical processing such as using one-way mathematical functions and then transmits the computed response back to the transaction gateway device where the authentication challenge was made (304).

Authentication of the document or product is determined by inspecting that the computed response matches the second identity component on the document or product (305). Or in the instance that both first and second unique identity components were sent for processing, authentication is determined via the receipt of a confirmation message.

In a particular application for stand alone processing, the transaction gateway device may comprise the alternative means to read both the first and second unique identity components at the same time as the complete challenge response pair and then process the challenge using its own challenge response processing means and then determine that the challenge matches the response and thus determine that the pair is authentic and then make a sound or display a positive condition, This serves to simplify the use of the invention when it is provided to security personnel who just want to determine that a document or product is authentic and or still for valid use.

This procedure may also be used as an alternative means to verify that the challenge and response comprise a matched pair. In such an embodiment, both the challenge and the response are transmitted to the challenge response server using a transaction gateway device, which in a simple embodiment may comprise using a text message sent by a mobile phone. In complicated embodiments, the first and second components may be embedded in the same encoded 2-dimensional bar code or encoded image and captured by a camera. The response received from the challenge response server will then be just a confirmation that the challenge and response comprise a valid challenge response pair or a rejection that the challenge response pair is not valid.

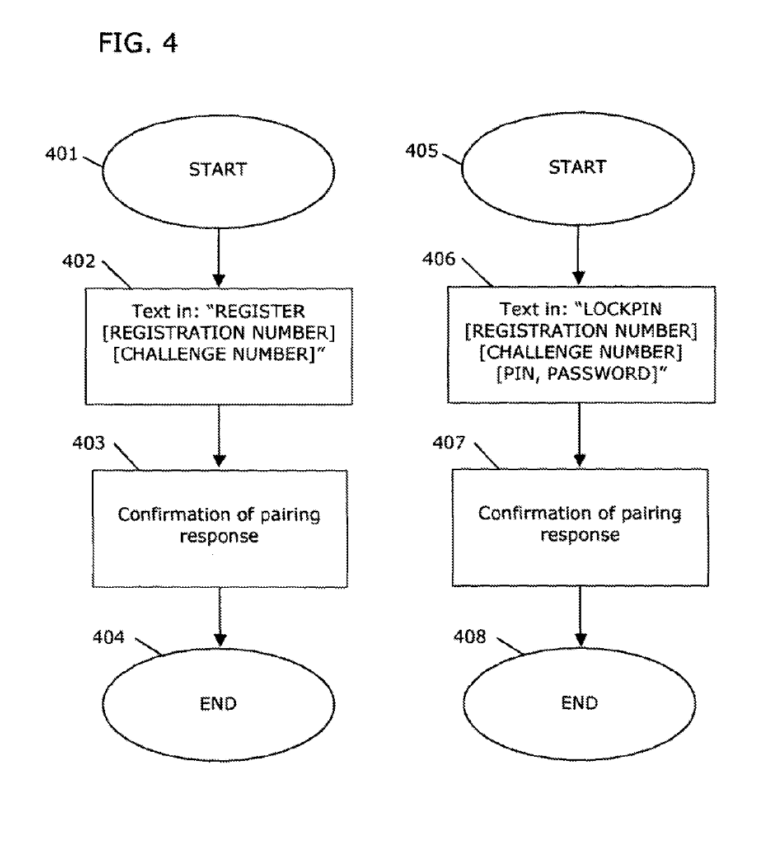

FIG. 4 illustrates two flow diagrams showing an example of the registration of a device with a challenge response authentication server and the registration of a PIN and password to be used for the activation and deactivation of an intervention code according to one embodiment of the invention.

Whenever a security document or product has its authentication challenged, it is often important for different applications to be able to identify the device, which is making the challenge. In particular, according to one embodiment of the invention, a method is taught for locking and unlocking the authentication process using a registered device and a registered PIN or password associated with that registered device and for challenge numbers registered to that device.

FIG. 4 outlines a method for registering a transaction gateway device. In this example the device may be a mobile phone, which is sending a text message to register a challenge number, which comprises a serial number or alphanumeric string. First the serial number is entered into the device using a specific format. The word ‘REGISTER’ may be used to identify the process. This is followed by the registration number and the document or product challenge number thus in the form: ‘REGISTER [REGISTRATION NUMBER] [CHALLENGE NUMBER]’ (402).

Upon receipt of a registration message in a correct format, the challenge response server creates a data file for the registered device and associates the challenge number with that device.

The registration number can take on different formats according to different applications. For example, it may determine the document or product class, or it may comprise the device ID or it may also be a PIN r password of some form. In some embodiments the registration number field may be left out where the device ID can be determined from the text message header or other part of the message. If the registration of the device is successful, the challenge response server issues a confirmation and sends this back to the device, which sent the registration message (403).

Once a device has been registered together with one or more first unique identity component challenge codes, it provides the means for a PIN or password to be registered to that device so that the authentication transaction can be modified by activation of an intervention code. To register a PIN and or password in this example, a consumer sends a text message to the challenge response server using the device registered against that first unique identity component code. in the example, this text message takes the form: ‘LOCKPIN [REGISTRATION NUMBER] [CHALLENGE NUMBER] [PIN, PASSWORD]’ (406). The challenge response server then adds the PIN and or password to the data file for this device and the registered challenge numbers.

For example, a document may comprise a serial number 401905504 and a product type with registration number OLYMPICS2012. A consumer could send in an SMS text message comprising the text: LOCKPIN [OLYMPICS2012][401905504] [8644, STANLEY].

The challenge response server then determines the identification of the device from the text message ID and checks to see if the device is registered. If the device is registered with the challenge response server it proceeds to check that the challenge number is registered to that device ID. If this is determined to be correct, then the challenge response server stores the PIN or password as an activation code for that device in association with the particular registration number information if any is present, and the particular challenge number. While only one challenge number is used in this example, it should be clear that the message may contain one or more challenge numbers such as a list of numbers such that the form of the message becomes LOCKPIN [REGISTRATION NUMBER][CHALLENGE NUMBER #1] [CHALLENGE NUMBER #2] . . . [CHALLENGE NUMBER #20] [PIN, PASSWORD] as an example for registering 20 different challenge numbers. Alternatively, sequential challenge numbers may be registered using LOCKPIN [REGISTRATION NUMBER] [CHALLENGE NUMBER #1+20] [PIN, PASSWORD]. These are just examples and all such message formats may be used to match the device and format of the message protocols used. If the registration of the PIN and or password is successful, the challenge response server transmits a confirmation message back to the registering device (407).

Now the registered device may use the PIN and or password to cause an intervention code to become activated in association with a particular challenge number. When activated, the challenge response server computes the incorrect response for the challenge and the authentication is determined to be invalid. Such a locking message for a registered device may comprise the following format: LOCK [CHALLENGE NUMBER][PIN, PASSWORD]. If the locking procedure is correct, the PIN or password or a derivative of one of them is used with the challenge response computation process to cause the process to no longer compute the correct response for the challenge association with a particular document or product. In different embodiments, the PIN or password may be the actual activation code. In other applications a master password may be set to be able to interact with a whole class of registered challenge codes and render their authentication challenges to be determined to no longer be valid.

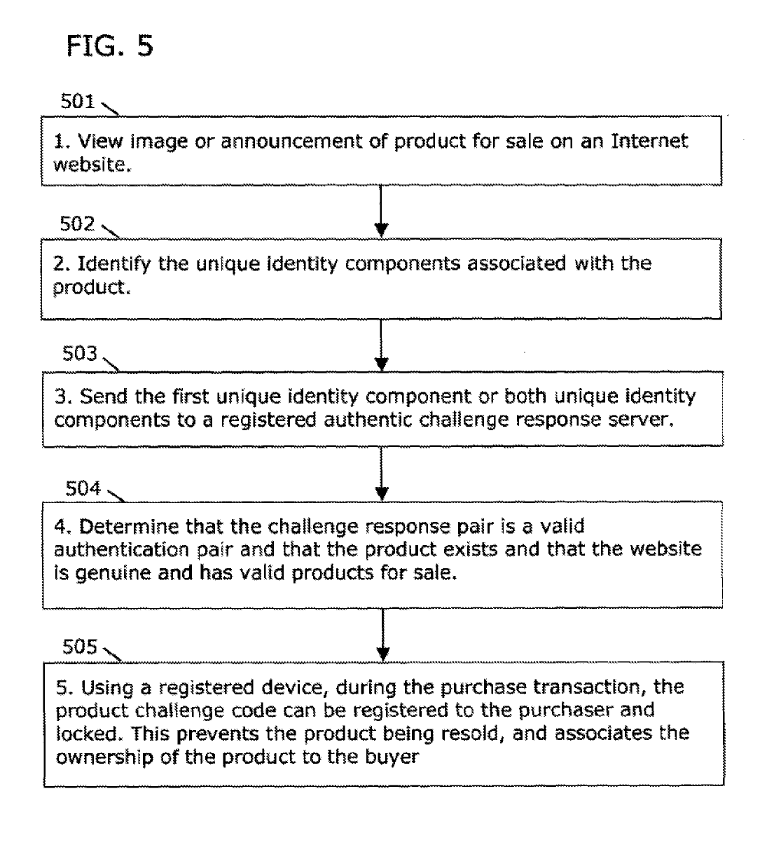

With reference to FIG. 5 is shown a flow diagram of an example of an Internet sales transaction using the controlled authentication transaction method according to one embodiment of the invention.

In particular, the invention provides a significant level of improved security when making purchases using non-regulated sales channels such as over the Internet. The challenge with Internet sales transactions is that there is limited means to determine that the website is genuine and that the seller is the owner of the products advertised or that the products even exist. The invention provides the potential purchaser with an independently verifiable method to enable him or her to determine that the products have been registered and that they are indeed available from that website. Moreover, the invention enables the potential purchaser to determine independently that the products are genuine and that they have not yet been sold to anyone else. In particular, the invention can serve to establish that the products exist and are currently owned by a particular organisation or person.

In addition to this valuable process of verification and authentication, the invention further makes it possible to register new ownership of the product being sold during the transaction process, thus providing a means to indicate to other potential buyers that the product has been sold and is no longer available for sale by the original seller.

The method of device registration and the registration of unique challenge numbers and a PIN or password have been described earlier. The invention thus makes it possible for the potential purchaser to lock the product with a registered PIN or password such that in the case of purchasing events tickets, the authentication of the tickets can be modified to render them non-authentic. This provides the purchaser with the peace of mind that the events tickets can be rendered invalid while they are in transit and can be rendered unusable at the event should a 3^{rd} party attempt to use them to enter the event. In this example, the added benefit is that the challenge response is printed on the ticket itself and the authentic owner of the ticket is registered during purchase such that there can be no misunderstanding whether a ticket was authentic and valid for use or not. Should a 3^{rd} party attempt to use the ticket at an event, they are liable to being caught at the turnstile gate.

The sequence of actions now available to improve the Internet purchase transaction is the following. The consumer views an Internet website or the announcement of a product that is available for sale (501). The consumer then reads or obtains the two unique identity components that comprise the challenge response pair (502). Either the first unique identity component is sent to a challenge response server and the response compared with the second unique identity component or both components are sent to the challenge response server and the received response validates that the two components comprise an authentic valid challenge response pair (503). At this point the consumer has validated that the pair is valid and authentic, that the product exists and that advertised product is authentic, that the website is genuine and has valid products for sale (504).

In particular, the challenge response authentication process further provides data to the potential purchaser during the product verification and validation process such as details of the current owner, the current point of sale identification such as the website address and the like.

The invention further provides the means to render the product unavailable to any other interested person at the moment that the purchase transaction is effected. The purchaser registers a device during the purchase transaction and assigns a PIN to the first unique identity component and activates the LOCK code to lock the product to his or her registered device and render the response invalid for that particular locked first unique identity component. At the same time the registering of the product to the device with a code now assigns ownership of the product to the purchaser (505).

In a further embodiment the challenge response authentication process can be embedded into the Internet website where the product is being advertised for sale. The challenge response codes associated with the product may be verified using a screen hot key and the validation that the challenge response pair is authentic or that the computed response matches the response can be seen on screen, This may be shown in a separate popup window or the like. In this way a consumer can verify that the response coming back from the independent authorised challenge response authentication server matches the number shown on the photograph of the product.

Registration of the device can be replaced by allowing, the consumer to become registered with the website. More secure identification determination may be used to prevent a consumer inventing an identity.

For example, if one considers an online trading site like www.ebay.com it can often happen that a trader will advertise product that he does not yet possess. Any photographed product comprising authentic challenge response codes must exist by definition. Often the legitimacy of the seller is questioned and whether he does actually still own the product advertised. The online buyer can interrogate the challenge response server and quickly establish which product is associated with the particular challenge response codes. In addition the same challenge response server will identify the current owner of the product. In some instances, the online trading website will store data relating to the history of transactions relating to a particular product comprising authentic challenge response codes. The invention provides the means to lock the transfer of ownership and thus render it impossible for a trader to claim ownership of a product that is registered and locked to a particular person or organisation.

In addition, over time the challenge response server and its associated database will store a history of transactions relating, to a particular product. It will be possible to verify the number of different owners of a product and to determine how many products a particular person owns.

Essentially, the challenge response invention provides an independent means to determine if something is indeed authentic. If a product is awarded a best-in-class award, or if a claim is made that a product has certain valuable attributes, a challenge response transaction sent to the appropriate authentication server can quickly determine if the claims made are indeed genuine and supported by a registered accreditation from an authority. For example, a hotel may claim to be 4-star, or a restaurant may claim to be mentioned in a particular guide. By sending the challenge code to the appropriate authentication authority challenge response server, the response will include data to support the claim such as the accreditation given and the name of the hotel or restaurant. All genuine certificates or books or documents or paintings or other works of art may also make use of the invention to help establish that they are indeed authentic.

Manufacturers may also etch challenge response codes to products before they are sold and in this way their authenticity can be verified. Different companies may operate their own challenge response servers so that they can monitor the history of use of products.

Consumers may also purchase challenge response code pairs and assign these to valuable objects and register ownership of these products. Should these products be stolen and rediscovered elsewhere, the legitimate owners of the products can be determined by sending authentication challenges using the challenge response codes on the products to the challenge response server.

Often there are disputes arising from trading websites regarding the postage and arrival of posted products. Consumers generally use courier companies for delivering products of high value and the products are tracked from seller to buyer. The problem arises often with products of low value for which the sales price does not justify the cost of sending something recorded delivery or the buyer claims the product did not arrive.

The challenge response invention can be used to resolve this issue and can also be linked to the purchase transaction. For example, low cost goods may be sent from the seller using the postal service without paying any additional significant sum for recorded delivery. In one embodiment, the seller simply buys a challenge response transaction code and attaches this to the package to be posted. The sales transaction thus includes the creation of a unique challenge response code associated with the transaction wherein the address of the buyer is used to corrupt the challenge response computation and lock the response. This provides a secure means to protect both the buyer and the seller since both are informed of the challenge response associated with the transaction and postage of the product. The website may issue a barcode challenge response transaction code and make it available for printing in a format which can be read by existing postal tracking systems. The seller sticks the challenge response barcode onto the outside of the package to be posted. At the post office, it is logged into the system and tracked across the country as it moves between different sorting offices. The visibility of where the product is at all times can be made visible to both buyer and seller. The transaction is private and can be made exclusively visible to only the two parties. At the moment the package is delivered to the buyer, the postman confirms that the package was delivered and causes the address code to be sent to the challenge response server and unlock the authentication process, As soon as the challenge response computation is correct, the payment can be released.

A benefit of this method is that the payment transaction may be directly linked to the challenge response transaction itself. Today, the buyer and seller are often linked by a middleman payment transaction company, wherein both parties are registered to pay and to receive money respectively. This has the disadvantage that the buyer pays effectively in advance before he receives the goods, while the buyer has to wait for the product to arrive. By linking the transaction to a challenge response transaction code, the actual transfer of funds to effect the payment can be delayed until the package is confirmed delivered by the postal service. In such a case, the payment transaction itself can generate a challenge response which has its authentication made invalid, such that the challenge response server does not generate the correct response pair because it is locked by a code generated by the transaction itself.

In another embodiment, the commit-to-buy purchase transaction generates a challenge response identification certificate, which contains a unique identifier and which is stuck to the outside of the product package and sent to the buyer. The same transaction generates a different receipt certificate for the buyer, which contains the unique identifier found on the certificate on the outside of the package as well as the unlock code for the challenge response controlling the payment transaction. To be allowed to receive the posted package, upon arrival, the buyer most show the receipt certificate and or hand it to the person delivering the package and or post the receipt certificate to the seller and or send the seller an email or text message containing the unlock code for the payment transaction. Only upon receipt of the unlock code, such as entering the unlock code into a data-field on the trading website when logged in as an authorised person, can the seller gain access to the payment.

In other embodiments, the challenge response authentication process can provide a safe and secure means to activate systems and events. The use of a challenge response server combined with the means to control the authentication by activating intervention codes thus causing the response to be incorrectly calculated when the intervention codes are active, provides a secure means for event control. For example, an employee wishing to enter a controlled area for which he has legitimate access rights need only send the challenge to the server via a registered device, or alternatively send both components of the challenge response pair to the server, and the server will then determine that the challenge response pair is valid and then cause an event to happen such as causing a barrier to open or a door to unlock, by sending a message to the barrier or door lock. Employees can thus be assigned challenge response codes and their access privileges are thus determined at the challenge response server.

Similarly, challenge response transactions can also be used to purchase products from vending machines. Registered devices may send the challenge response associated with a product or with a vending machine product, and the response can be sent to a processing means associated with the vending machine and cause it to deliver the product to the purchaser. Alternatively, the challenge is associated with a person and the transaction comprises sending a message to an authentic challenge response server, which identifies the product to be bought, and or the location and or the price. This can be done by sending a single challenge response pair, which identifies the location, the vending machine ID, the product type and the price. In this transaction, the unique challenge response data associated with the purchaser or the registered device, added to that of the product will result in a. response being sent directly to the vending machine to deliver the product, or the purchaser receives a message containing a code which can be entered into a keypad on the vending machine to deliver the product. Payment is made by charging the purchaser or the subscription holder of the device. Alternatively, a consumer may purchase challenge response codes to a certain value. These challenge response codes can be rendered invalid by a locking code and unlocked at the moment that they will be used for purchase. Alternatively, the registered device may store an identity code or PIN or password, which is accessed by way of a PIN and used to unlock the challenge response code during the purchase transaction. In this way payment is made from the device itself without needing a credit card.

Credit card transactions may be improved using a challenge response pair. The card may comprise the challenge, which is sent to the credit company with a challenge response pair, which identifies the authentic purchase transaction. The response requires simply providing the seller an identification code, which is identical to the response generated by the transaction. This may be entered into the payment transaction terminal to complete the transaction. The invention lends itself to all manner of product identification processes, product authentication processes, and to a means for defining absolute ownership of products comprising unique identities. In addition, the challenge response invention provides the means to interact with systems safely and securely according to different access rights, which may be modified in real time according to changes in status. (Sep. 18, 2010).

In particular, the invention makes possible the encoding of a security document with a two dimensional barcode or other encoded image which can be read by a suitable image reading device or captured by an image capture device and processed by a processing means. In one example the two-dimensional barcode or encoded image may comprise both the challenge and response pair. As described earlier in other embodiments, it is possible to modify the challenge such that the response computed from the challenge is incorrect. A particular feature of one embodiment provides a security document with a printed encoded barcode or image wherein the said barcode or image comprises an encoding comprising a challenge response pair generated in association with the numerical representation of some additional encoding data such as a PIN, and or a password, and or some biometric data, and or an ID card or a credit card, and or a sound byte, in this embodiment, the encoded challenge response pair cannot be determined from the encoded image without the said encoding data being provided as well.

This embodiment lends itself to the online purchasing of event tickets. In one scenario, the technology enables a consumer to buy a ticket online as a registered person at an authorised website.

The consumer registers some form of encoding data for example a PIN comprising their Date of Birth (and a back-up favourite question and answer) with the purchase, or a credit card or an ID card or by speaking a word into a microphone linked to the computer which is subsequently digitised into a numerical code and the PIN or ID data or sound byte is then encoded with the Challenge Response into the encoding to be printed on the ticket. When the ticket has its authentication challenged using a suitable reading device and a local or remote processing module, the authentication process requires input of the encoding data to enable the challenge and response to form a matched pair.

In an alternative embodiment the ticket serial number forms part of the challenge and the consumer provides the missing part of the challenge. This missing part can comprise a 4 digit PIN, or a password, or a biometric scan derivative from a fingerprint, or a spoken word, which forms a digitised sound byte, or data from an ID card or credit card. The challenge response server is able to compute the correct response if the missing part of the challenge is provided during the authentication process. The response generated will be present in the same document encoding such that a single 2-dimensional barcode comprises part of the serial number and the correct response such that the barcode is validated as an authenticated barcode only if the missing data.

According to different applications, the barcode encoding of part of the challenge and the true response may be based upon a system-computed code, i.e. one that the consumer does not choose but one which is generated and emailed to the consumer.

In these examples, the advantage is that the complete challenge response pair is never present in the encoded image or barcode, which makes it impossible for a hacker to derive a representation of the challenge response pair from the barcode alone.

A further advantage of a numerical representation of a digitised sound byte as the missing part of the challenge code is that a microphone can be used at a ticket barrier and voice recognition software can be used to process the challenge response at high speed, which would not slow down the rate of ticket holders passing through the ticket barriers compared to current flow rates of persons passing barriers where only the validity of the ticket is determined. The invention thus provides a capability to associate a person with a particular ticket holder quickly and accurately.

Without the provision of the missing part of the challenge data, the ticket cannot be authenticated and will not allow a person past the ticket barriers. This gives peace of mind to the true owner of the ticket that it cannot be used by anyone else if it is mislaid.

In different application areas, such as with the use of Judicial and Non-Judicial Stamp Papers, the technology provides a safe and secure method to validate that such a paper is authentic. For example, if such a Non-Judicial Stamp Paper (N-JSP) relates to the sale of a bicycle, the potential buyer need only send off the N-JSP document ID code using a mobile phone and he or she will receive some data about the bicycle for sale and a request for the seller to enter a PIN. The buyer then obtains the PIN from the seller and sends the PIN from the buyer's own mobile phone and the response will be the correct response printed on the document and a data message comprising the ID of the N-JSP, ID of the seller, and details and ID of the bicycle (such as a challenge response pair encoded onto the bicycle frame) and the response encoded on the document. When the seller is paid, the buyer sends the challenge response code to the server and the N-JSP record becomes registered to the buyer's mobile phone number. The existing N-JSP record now forms proof of purchase and transfer of ownership for the transaction. Many different variations of this type of transaction are anticipated.

In an application relevant to visa vignettes, an issued passport visa vignette may comprise an encoded challenge response pair which may be complete or which may be partially based on some missing data. In either case, the invention now provides the visa issuing authority with the means to render a visa invalid after it is issued and stuck into a passport. Should an issued and dispatched visa need to be withdrawn, the issuing authority need only activate an intervention code at the server which will cause the challenge response processing means to miscalculate the correct response and thereby determine the visa to be revoked when the visa undergoes authentication at the airport check-in or other point of embarkation.

In an application relevant to social workers and to law enforcement officers and to healthcare workers who visit people at home, there is a need to reassure members of the public that the person at the door is genuine. The invention provides a capability for the person at home to read an ID card through the door while the door chain may still be attached. The ID card serial number can be sent by text message to a genuine server, which may respond with a request for a password or PIN or answer to a question. This answer can be then sent to the server as a second message, which may elicit a response detailing the personal data on the ID card and even data describing a visit at that very location within a particular timeframe. In such a way, the spoken PIN not present on the ID card and messages sent to an independently verified challenge response server provide the basis for a secure authentication process which will give the home resident peace of mind that the visitor is genuine. (Oct. 7, 2010).

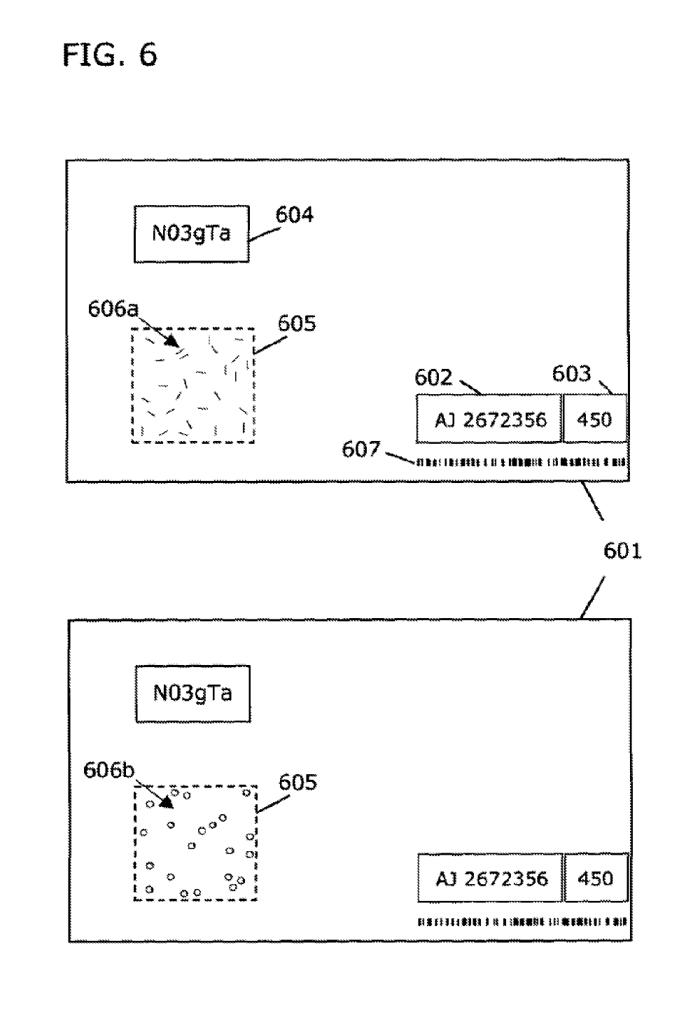

Now with reference to FIG. 6 is shown an embodiment according to the invention, which shows how a random element of the document structure itself may be used to generate the PIN, which combines with a document serial number to form the challenge and thereby improve the security of the document.

This process of generating the PIN from a random element of the document structure itself has particular relevance to security documents such as bank notes, passport visa vignettes, ID cards, passports, birth certificates and personal identity documents and the like, and branded products, and pharmaceutical packaging.

According to FIG. 6, a security document (601) is shown having a serial number (602) and a PIN (603). A challenge response (604) is also shown. Together the serial number (602) and the PIN (603) form the unique challenge, which is sent to a challenge response processing means to generate the unique challenge response (604).

The challenge response (604) may be cut into the surface of the document such as into an Optically Variable Device (OVD) or into a zone of the document bearing Optically Variable Ink (OVI). In different applications the challenge response (604) may be in the form of a bar code or may be simply printed upon the surface of the document, In the bar code example, additional elements of the barcode may be added or encoded into the barcode according to a predetermined sequence.

The PIN number can be of any length as required. In this example a PIN (603) of 3 characters is shown having a value 450, which is added to the serial number (602) shown as AJ 2672356. The challenge response (604) on the security document is the challenge response generated when the whole number AJ 2672356 450 is sent to be processed by the challenge response processing means.

The PIN provides a feature, which adds additional security to the document. The PIN can comprise a number or alphanumeric string in any language as required and be of any size or length. The serial number (602) is unique, thus a serial number with an appended PIN (603) is also unique.

One of the challenges faced by security printers is that a printed document can be copied using a scanner. The following embodiment of the invention addresses this challenge.

Paper documents comprise a paper substrate made of paper fibres. These fibres comprise random surface patterns, wherein no two paper documents can ever have the same fibre orientation. Thus a high-resolution image of the random paper fibres in a part of the paper document can be used to generate a numerical signature of that part of the document. This random signature can form the PIN, which is added to the serial number SN.

Alternatively, other random elements of the security document itself may be used to generate the PIN. Security document printers increasingly use security papers, or ID card substrates, which incorporate micro-fibres or additives, which fluoresce in the visible range when irradiated by UV light. This random element of the paper or substrate itself can be used as a means to authenticate the document.

Thus while it may be relatively easy to copy the visible serial number (602) and PIN (603) and even in some cases the visible challenge response (604), it is not possible to copy the fibre orientation or some other random feature of the material of which the document is made. Thus it is one embodiment of the invention to use a random and unique element of the document to generate the PIN, and to use this random element to protect against anti-counterfeiting. In this way, the document is determined to be valid if an authentication process reads the random element and computes a numerical signature from the random element, and then determines that the numerical signature is identical to the PIN. Thus the serial number and PIN form both a basis for uniquely identifying the document, for obtaining a data channel via the challenge response transaction as well as determining that the document is itself authentic, A suitable reader may be used with a capability to illuminate the document with Ultraviolet light and to determine that the numerical signature generated. is identical to the PIN (603).

The random element may take on many forms to suit different applications. With reference to FIG. 6 is shown an area (605) depicting a random distribution of elements such as security fibres (606a), which fluoresce in the visible range when illuminated by UV light. The number of fibres, and or the colour of the fibres and or the orientation of the fibres which are determined to be in one or more predetermined zones of the security document may be used to generate a numerical signature which then forms the PIN (603).

In other applications, the area (605) may be formed from dots of pigments (606b) of different chemical properties, which fluoresce with different colours when illuminated by UV light. Similarly, a numerical signature is formed from processing the number of pigment dots and or the colour of the pigment dots, which fluoresce in the visible when illuminated by UV light.

Different additives may be added to the paper or document substrate such as a micro security fibre or thread element, or particle or pigment, wherein each has one or more different measurable physical attributes which can be used to generate a unique numerical signature such as when irradiated by different frequencies of electromagnetic radiation.

According to different applications, the random element may be a barcode such as a 2D barcode representing a random number cut into the OVD or OVI. The random element R may be a magnetic encoding of a particular part of the document, which can be read by a suitable magnetic reader. The numerical signature may be generated by treating the document as an encoded grid and using the serial number as a filter to select and read surface features of different grid elements of the document. For example, for a 10-digit serial number, the document is divided into 10 vertical strips wherein each strip is divided into 10 equal grid elements for a numerical digit 0-9 or into 26 grid elements for an alphanumeric character A-Z. Thus the processing algorithm uses the serial number to select and read grid elements to generate a numerical representation of some measured physical attribute of the document at each grid element location, which is used to encode the PIN. Whichever data collection method is used to determine the numerical representation to generate the PIN, must be used in the document authentication reader.

Since visibly, the document may be identical to other documents of the same type, which is the case with bank notes, the random element feature used for high security applications, should preferably be an invisible feature. In a preferred embodiment, it may suffice to read a document surface feature from a preset field of the document or measure a physical attribute of the document at a particular location or number of locations, such as the part of the document in the vicinity of the printed PIN. In this way the location of the PIN on the document provides the location where the random element may be found, from which the PIN was originally generated. In other applications this is not necessary as the entire document can be quickly scanned under UV and the matching of the numerical signature derived from the random element area (605) or from a number of predetermined areas can be easily determined.

Photo chromic inks may be used in a document, which cause changes in the colour of the ink under irradiation by different electromagnetic frequencies such as with UV light. Alternatively thermo chromic inks may be used which cause changes in the colour of the inks when the substrate of the document is heated.

Both these types of ink may be used with the appropriate irradiation frequencies and or at the appropriate temperatures to modify the appearance of the document when the numerical signature is first computed to form the PIN and during the authentication process.

In different embodiments a micro barcode (607) or micro perforation or other surface encoding may be added to the document to assist with the machine reading of the encoded information. In particular, this micro barcode may contain encoded data, which can direct the authentication reading process to gather appropriate random data from one or more predetermined areas (605) of the document to generate the numerical signature, which forms the PIN. The barcode may also comprise data relating to the challenge response processing means such as an IP address or destination to where a challenge response should be sent and or data relating to an Internet website to give authorised persons access to the software download needed to authenticate a security feature on a particular security document.

With regard to plastic banknotes or to ID cards or for any personal identity document, the random element may comprise a feature embedded within one layer of the substrate of the document. One can also envisage encoding different grid elements of the document with a magnetic field orientation according to two or more orientations and reading the magnetic orientation of predetermined parts of the document such as by using the serial number to select which parts are read. Such a magnetic encoding can be formed by using magnetic inks whose magnetic orientation is encoded by an encoding magnetic field, which is locally applied to different parts of the document and which is encoded into the document when the ink dries. (Oct. 19, 2010)

In summary, the invention provides a challenge response authentication technology, which is scalable and low cost, and one, which is convenient and easy to use. It can readily be customised as required into diverse embodiments to suit different applications and adjusted to all cognitive requirements. The technology matches existing user behaviour and provides an important security service. The invention particularly lends itself to the provision of a service for authenticating people in territories where no national ID card is in use. Such a system emphasises trust in society and thus further supports policies, which favour a big society agenda. (Oct. 7, 2010)

While the present invention has been described herein with reference to particular embodiments thereof, a latitude of modification, various changes, and substitutions are intended in the present invention. In some instances, features of the invention can be employed without a corresponding use of other features, without departing from the scope of the invention as set forth. Therefore, many modifications may be made to adapt a particular configuration or method disclosed, without departing from the essential scope and spirit of the present invention. It is intended that the invention not be limited to the particular embodiments disclosed, but that the invention will include all embodiments and equivalents falling within the scope of the claims.

What is claimed is:

1. A system for encoding and controlled authentication of a security item wherein each item comprising one of: a security document, a ticket, a product, and product packaging materials wherein
each security item being encoded with, or associated with, at least two unique identity components wherein a first unique identity component being a derivative of a second unique identity component and wherein together both first and second components comprising a challenge-component response-component pair, and wherein
at least one unique identity component being printed upon, or cut into the surface of said document or product or product packaging or etched or integrated into an Optically Variable Device (OVD) or into a zone bearing Optically Variable Ink (OVI), or magnetically encoded into magnetic ink, or comprising a numerical representation of a random component of the said surface, or comprising a numerical representation of a random component of the said document or product or packaging structure, or forming a digital certificate to be associated with said product, and
said at least one unique identity component comprising one of: a number, an alphanumeric string, an encoded image, a barcode, a pattern, and an image comprising different patterns when illuminated by light, and
at least one unique identity component being input into or read by a reading device wherein said reading device being a stand alone device comprising a local challenge response processing device comprising software and/or said reading device comprising a transaction gateway device being connected to a remote challenge response processing device comprising software, and wherein
a unique response-component being computed from a unique challenge-component by said local and/or remote challenge response processing device comprising software using a complex mathematical algorithm, and wherein
said complex mathematical algorithm system checking authenticity by determining a correct relation between said challenge-component response-component pair, and wherein
said system further comprising at least one key code which is provided to the complex mathematical algorithm, wherein said key code being one of: a number, a password, a derivative from biometric data, a derivative of a security document number, and wherein
said at least one key code changing said challenge-component response-component pair relation so that when the said response component is processed from the said challenge component without said key code, said challenge response processing device comprising software computes a first response and when the said response component is processed from the said challenge component with said key code, said challenge response processing device comprising software computes a second response.

2. A system for encoding and controlled authentication as disclosed in claim 1 wherein said first response determines the security item to be non-authentic and wherein said second response determines the security item to be authentic.

3. A system for encoding and controlled authentication as disclosed in claim 1 wherein said complex mathematical algorithm used to create said second unique identity component and to derive said response further comprising one or more one-way mathematical functions.

4. A system for encoding and controlled authentication as disclosed in claim 1 wherein said reading device being input with, or reading said first unique identity component or said first and second unique identity components by using a barcode reader, or an encoded-image reader, or illuminating said first unique identity component under one or more spectral frequencies and using an optical reading device.

5. A system for encoding and controlled authentication as disclosed in claim 4 wherein said reading device being one of:
a. a stand alone reading device comprising said local challenge response processing device comprising software;
b. a reading device further comprising a transaction gateway device connected to said remote challenge response processing device comprising software, wherein,
said reading device being input with, or reading, at least one unique identity component and producing a mathematical representation of the challenge, and wherein
said transaction gateway device further passing said mathematical representation of said challenge to said local challenge response processing device comprising software, or to said remote challenge response processing device comprising software via a telecommunications network wherein
said challenge response processing device comprising software processing said mathematical representation of said challenge and deriving said response and comparing this with the second unique identity component of said pair, and device comprising software for authenticating said security item by deriving said processed response from said unique mathematical representation of said challenge and, by determining that the relation between said challenge and said response is correct.

6. A system for encoding and controlled authentication as disclosed in claim 5 wherein said challenge response processing device comprising software further comprising a data storage device comprising software for associating a challenge with an intervention code and to store said challenge together with said intervention code in said database, and device comprising software to receive a first instruction for activating said intervention code so that said challenge response processing device comprising software further determining an incorrect response for said challenge which is associated with said active intervention code so that the received response no longer matches the second unique identity component and/or device comprising software to receive a second instruction for deactivating said intervention code associated with said unique challenge for allowing said challenge response processing device comprising software to compute the correct response to the challenge.

7. A system for encoding and controlled authentication as disclosed in claim 5 wherein said remote challenge response processing device comprising software further comprising device comprising software for sending the computed response back to said transaction gateway device from which the challenge was received, and inspection device comprising software for determining that said computed response matching said second unique identity component associated with said security document or with said product, and wherein
said database further associating different data types with particular first identity components, and wherein
said remote challenge response server comprising device comprising software to register at least one transaction gateway device and associate said registered device with a unique first identity component challenge in said database, wherein said database stores a data record of each challenge and or the time of the challenge and or the location where the challenge was made, and wherein data files being sent across a telecommunications network to said database wherein said data files being associated with a particular set of challenge response transaction data records for allowing events to be monitored in order to provide responses according to different applications, and/or wherein said database being associated with national data archives or company information or validity checks of ID cards or product registration records or pharmaceutical product data.

8. A system for encoding and controlled authentication as disclosed in claim 7 wherein said challenge response processing device comprising software further comprising device comprising software for locking the authenticity of said security document or said ticket or said product by associating said intervention code with a key code, and device comprising software for sending a first instruction for activating said intervention code for causing an incorrect response to be computed by said local challenge response processing device comprising software and/or by said remote challenge response processing device comprising software while said intervention code being active, and device comprising software for unlocking the authenticity of said security document or said ticket or said product by associating said intervention code with a key code, and device comprising software for sending a second instruction for deactivating said intervention code for enabling the correct response to be computed by said challenge response processing device comprising software.

9. A system for encoding and controlled authentication as disclosed in claim 7 wherein said challenge response processing device comprising software further comprising device comprising software to register a user device having a unique identity, wherein said user device being at least one of: a fixed or wireless device, a device having an IP address, a device having a Media Access Control (MAC) address, wherein said challenge response processing device comprising software authorizes said particular user device to be further associated with a key code by storing said particular device unique identity and a key code in said challenge response processing device comprising software database wherein each of said first unique identity components further comprising a unique challenge and being associated with a unique authentication process and said registered device further being authorized to send instructions to said local and/or remote challenge response processing device comprising software and or device comprising software for activating and deactivating said intervention codes associated with a particular challenge.

10. A system for encoding and controlled authentication as disclosed in claim 7 wherein said local challenge response processing device comprising software and/or said remote challenge response processing device comprising software further comprising: device comprising software to associate different data types with said first unique identity components or in accordance with different applications, device comprising software for receiving one or more first unique identity components from a registered user device, device comprising software to store data received from a registered device, and device comprising software for processing and transmitting a response to the said device comprising one or more associated data types.

11. A system for encoding and controlled authentication as disclosed in claim 7 wherein said system further comprising device comprising software to provide to said user a plurality of information of a pharmaceutical product or a food product or a perishable product or a consumer product, and wherein said database comprising device comprising software for being updated by activating one of a plurality of different intervention codes to cause a challenge response to be transmitted with a data message about said product.

12. A system for encoding and controlled authentication as disclosed in claim 7 wherein said system further comprising device comprising software to provide a plurality of information about a pharmaceutical product comprising said unique challenge response pair printed or etched into the surface of said pharmaceutical packaging or blister pack, wherein said challenge or challenge response pair being sent to a challenge response processing device comprising software by sending said first unique identity component and/or sending said first and second unique identity components, and/or sending consumer data, to a local and/or remote challenge response processing device comprising software, by entering data from the packaging into a data reading device and/or entering consumer data and sending this to a local and/or remote challenge response processing device comprising software, wherein when said challenge response from said local and/or from said remote challenge response processing device comprising software being identical to the second unique identity component on the packaging, or said first and second unique identity components being determined to be a valid challenge response pair, then said consumer further receiving a product data message containing the date of manufacture and/or place of manufacture and/or point of sale and/or date of sale and/or use-by date and/or product description and/or contraindications and/or warnings of side effects and/or use instructions, and/or product warning reports, and/or said system further comprising device comprising software to determine real market data of the number and locations of said consumers using one or more particular pharmaceutical products.

13. A system for encoding and controlled authentication as disclosed in claim 7 wherein said unique challenge component being a serial number, and said serial number and an encoding forming said unique challenge to be sent to said local and/or said remote challenge response processing device comprising software to generate said unique challenge response, wherein said encoding comprising a number or alphanumeric string in any language and of any size or length, and wherein said encoding being a numerical signature of a high-resolution image of the product surface or security document substrate, or a numerical signature of the orientation and or distribution of visible fibres and/or random invisible features in a part of said substrate or paper of said security document generating said numerical signature from an area of said security document, and wherein said substrate or paper visible fibres incorporating additives or micro security fibres, and/or said additives further fluorescing in the visible range when irradiated by UV light, and/or said reader illuminating said security document with light of a particular frequency range and further determining by said local challenge response processing device comprising software and/or sending said read data to said remote challenge response processing device comprising software for generating said numerical signature, and further said inspection device comprising software determining if said numerical signature being identical to said encoding.

14. A system for encoding and controlled authentication as disclosed in claim 13 wherein said substrate or paper area having a unique number of fibres and/or of one or more unique colours and/or having one or more orientations, and/or said area being formed from dots of pigments of different chemical properties being visible or fluorescing with different colours when illuminated by UV light being an Optically Variable Device or OVD, and/or wherein said numerical signature being formed from processing the number of pigment dots and/or the colour of said pigment dots, wherein said pigment dots fluorescing in the visible when illuminated by UV light for generating said unique numerical signature being Optically Variable Ink or OVI, or wherein different additives being further added to the paper or to said security document substrate wherein said additives being micro security fibres or thread elements or particle or pigments wherein each having one or more different measurable physical attributes for generating said unique numerical signature forming said encoding when irradiated by one or more different frequencies of electromagnetic radiation.

15. A system for encoding and controlled authentication as disclosed in claim 13 wherein said substrate or document area further comprising a random element (R) being a barcode or two dimensional barcode representing a random number cut into the OVD or OVI, and/or said random element R being a magnetic encoding of a particular part of said security document, wherein said reader being a magnetic reader, or said numerical signature being generated by treating the document as an encoded grid and using said serial number as a filter to select and read surface features of different grid elements of said security document in order to generate a numerical representation of some measured physical attributes of said security document at each grid element location, wherein said reader comprising a processing algorithm using said serial number to select and read grid elements.

16. A system for encoding and controlled authentication as disclosed in claim 13 wherein said substrate or paper area being further printed with photo chromic inks causing changes in the colour of the ink under irradiation by an appropriate electromagnetic frequency radiation such as UV light, or thermo chromic inks causing changes in the colour of the inks when the substrate of said security document being heated at the appropriate temperature, and/or said security document further comprising a micro barcode or micro perforation or other surface encoding wherein said micro barcode comprising encoded data, allowing said authentication reading process to gather appropriate random data from one or more predetermined areas of said security document in order to generate said numerical signature forming said encoding, and/or said micro barcode further comprising data relating to the challenge response processing device comprising software such as an IP address or destination to where a challenge response should be sent and/or data relating to an Internet website to give authorized persons access to the software download needed to authenticate a security feature on a particular security document.

17. A system for encoding and controlled authentication as disclosed in claim 13 wherein said security document being plastic banknotes or ID cards or any personal identity document, wherein said random element further comprising a feature embedded within one layer of said substrate of said security document, or said security document encoding different grid elements with one or more magnetic field orientations wherein said reading device reading the magnetic orientation of predetermined parts of said security document by using a barcode or said serial number to select which parts are to be read, wherein a magnetic encoding being formed by using magnetic inks whose magnetic orientation being encoded by an encoding magnetic field locally applied to different parts of said security document and being integrated into the document when magnetic ink drying.
